(19) United States
(12) Patent Application Publication
(10) Pub. No.: US 2022/0048687 A1
(43) Pub. Date: Feb. 17, 2022

(54) SNAPPING FRAME FOR PRESSURIZED CONTAINERS

(71) Applicant: Graham Packaging Company, L.P., Lancaster, PA (US)

(72) Inventor: Mohamad Eydani Asl, Lancaster, PA (US)

(21) Appl. No.: 17/393,840

(22) Filed: Aug. 4, 2021

Related U.S. Application Data
(60) Provisional application No. 63/064,285, filed on Aug. 11, 2020.

(51) Int. Cl. B65D 79/00; B65D 23/08; B29D 22/00

(52) U.S. Cl. CPC B65D 79/0081; B29K 2067/00; B29D 22/003; B65D 23/0885

(57) ABSTRACT

A plastic container for storing a product. The container includes a base formed of a plastic material and sidewalls formed of the plastic material and extending upwardly from the base, ending in an open top adapted to be closed by a cap, and with the base defining an interior volume. The container also includes a snapping frame integrally formed in the base of the plastic material. The frame has a convex base shape before activation when the pressure in the interior volume is less than or equal to a predetermined critical pressure and has a concave base shape immediately after activation when the pressure in the interior volume is greater than the predetermined critical pressure, thereby increasing the interior volume and avoiding catastrophic failure of the container. Also disclosed are a method of using the container and a process of manufacturing the container.

### CROSS-REFERENCE TO RELATED APPLICATION

This application is a U.S. Non-Provisional application claiming priority to U.S. Provisional Application No. 63/064285 filed on Aug. 11, 2020, the disclosure of which is incorporated by reference herein in its entirety.

### TECHNICAL FIELD

The present disclosure relates generally to containers suitable for foods, beverages, personal care, household goods, automotive lubricants, and other products and, more particularly, to pressurized containers.

### BACKGROUND OF THE INVENTION

It is common knowledge in the food packaging industry, for example, that after a container is filled with certain foods and is closed, the container and its contents must be thermally processed to sterilize the food so that it will be safe for human consumption. See, for example, European Patent No. EP 2639197 of inventor Gustave Vogel. U.S. Pat. No. 4,880,129 assigned to Pechiney Plastic Packaging Inc. and titled “Method of Obtaining Acceptable Configuration of a Plastic Container After Thermal Food Sterilization Process” teaches a method of improving the configuration of packed plastic containers after thermal processing of the container and its contents.

Under these thermal processing conditions, plastic containers tend to become distorted or deformed due to sidewall paneling (buckling of the container sidewall) and/or distortion of the container bottom wall, sometimes referred to as “bulging” or “rocker bottom.”These deformations and distortions are unsightly, interfere with proper stacking of the containers during their shipment, and cause them to rock and to be unstable when placed on counters or table tops. In addition, bottom bulging is considered, at times, to be a possible indication of spoilage of the food thus resulting in the rejection of such containers by consumers.

Therefore, an object of the '129 patent is to alleviate the problems associated with bottom bulging and sidewall paneling of a plastic container which result from thermal processing. The patent explains that rocker bottoms and sidewall paneling may be minimized or prevented by pre-shrinking the container before filling and closing, by reforming the container bottom wall, by adjusting the headspace of gases in the container at each vacuum level, by proper container design, by maintaining a proper pressure differential between the inside and outside of the container, or by combinations of these factors. The '129 patent provides only a vacuum relief mechanism and does not address over-pressurization issues that can lead to explosion of a container during use of the container.

Packaging for personal care, medical, pharmaceutical, household, industrial, food, and beverage products often requires that the products be stored in the packaging (e.g., containers) under pressure. For example, pressurized containers for dispensing aerosols are well known in the art. An aerosol container can be any package designed to dispense its liquid contents as a mist or foam. Aerosol containers typically are constructed of metal in order to withstand the inherent internal pressure of aerosols. It is desirable to provide a plastic container capable of withstanding the internal pressures generated by an aerosol, however, because plastic has many advantages over metal. Some of these advantages include the ease and economy of manufacture, and aesthetic appeal to an end user. See, for example, U.S. Pat. No. 7,448,517 assigned to Clorox Co. Aerosol containers were developed in 1941 by the American chemist Lyle D. Goodhue and others for dispensing insecticides. Since that time a wide variety of products ranging from disinfectants to whipping cream have been packaged in aerosol containers.

The most common type of aerosol container consists of a shell, a valve, a “dip tube” that extends from the valve to the liquid product, and a liquefied-gas propellant under pressure. The valve mechanism is a multi-component system (a one-piece solution would reduce manufacturing and processing costs and, therefore, would be preferred). The liquid product is generally mixed with the propellant. When the valve is opened, the solution moves up the dip tube and out the valve. The propellant vaporizes as it is released into the atmosphere, dispersing the product in the form of fine particles. In foam packs, such as shaving cream, the propellant and product are present together as an emulsion. On release, the liquid vaporizes, whipping the whole into a foam.

The two main types of propellants used in aerosol dispensers are liquefied gas propellants, such as hydrocarbon and hydrofluorocarbon (HFC) propellants, and compressed gas propellants, such as compressed carbon dioxide or nitrogen gas. In an aerosol dispenser using the liquefied gas-type propellant (also known as a double phase propellant), the container is loaded with the liquid product and propellant, and pressurized to a pressure approximately equal to, or slightly greater than, the vapor pressure of the propellant. Because the container is pressurized to the vapor pressure of the propellant, a majority of the propellant is liquefied. Nevertheless, a small portion of the propellant will remain in gaseous form. As the product is dispensed, the pressure within the container will decrease and more of the propellant will enter the gas phase. In a compressed gas aerosol dispenser, the propellant remains in gaseous form when the container is pressurized for use.

Aerosol containers are generally safe as long as they remain intact. Pressurized containers such as polyethylene terephthalate (PET)-based aerosol containers can fail catastrophically, however, when the internal pressure of the container passes a critical threshold. Catastrophic failure of pressurized containers manifests itself in explosion of the container body or disengagement of the cap from the body—either of which could result in bodily injury.

Safety concerns raised by pressurized containers can be addressed by cap venting. In this method, small venting mechanisms are introduced in the container cap area. The vents are activated above the critical pressure and start releasing the pressurized content of the container until the pressure drops below the critical pressure. A drawback for this method is that the contents of the container are dispersed and are not contained when the container reaches the critical pressure. The inadvertent content release may impact the surroundings of the container and cause bodily injury.

Safety concerns raised by pressurized containers can also be addressed by introducing ribs into the container design. Ribs that expand gradually and slowly over time through a plastic permanent deformation can be used to create extra volume in a pressurized container. Two drawbacks of ribs are that the activation of this mechanism is not instant and the induced deformation is permanent. The slow response and gradual extensions of the ribs fail to prevent container failure when the internal pressure increase is fast. In addition, containers having permanent deformation and distortion after being exposed to a critical pressure may not be usable again.

To overcome the shortcomings of containers having vented caps, ribs, or both types of structural features, a new container is provided. An object of the present disclosure is to address safety concerns raised by pressurized containers. A related object is to avoid catastrophic failure of containers when their internal pressure exceeds a critical threshold. Another object is to avoid containers that have permanent deformation and distortion after being exposed to a critical internal pressure.

### SUMMARY OF THE INVENTION

To achieve these and other objects, and in view of its purposes, the present disclosure provides a plastic container for storing a product. The container includes a base formed of a plastic material and sidewalls formed of the plastic material and extending upwardly from the base, ending in an open top adapted to be closed by a cap, and with the base defining an interior volume. The container also includes a snapping frame integrally formed in the base of the plastic material. The frame has a convex base shape before activation when the pressure in the interior volume is less than or equal to a predetermined critical pressure and has a concave base shape immediately after activation when the pressure in the interior volume is greater than the predetermined critical pressure, thereby increasing the interior volume and avoiding catastrophic failure of the container. The geometry and thickness distribution of the convex base are functions of the overall shape, volume, thickness, and operating pressure and temperature of the container.

Also disclosed is a method of using the container for storing a product. The method includes providing a container having (i) a base formed of a plastic material, (ii) sidewalls formed of the plastic material and extending upwardly from the base, ending in an open top adapted to be closed by a cap, and with the base defining an interior volume, and (iii) a snapping frame integrally formed in the base of the plastic material, wherein the frame has a convex base shape before activation when the pressure in the interior volume is less than or equal to a predetermined critical pressure. Next, the method includes allowing the pressure in the interior volume to increase above the predetermined critical pressure, at which pressure the snapping frame activates and has a concave base shape thereby increasing the interior volume and avoiding catastrophic failure of the container.

Further disclosed is a process of manufacturing a container for storing a product. The process includes selecting a plastic material having predetermined values for Youngs Modulus (E), Shear Modulus (G), Bulk Modulus (K), Loss Modulus (E′), Storage Modulus (E″), creep compliance properties (Prony coefficients), and energy release rate (dE/dt). A container is provided defining an interior volume and including a base formed of the plastic material and sidewalls being formed of the plastic material, having a thickness, extending upwardly from the base, and ending in an open top adapted to be closed by a cap. The operating and critical pressures and temperatures of the container are defined. A snapping frame is designed having a substantially convex base shape based on one or more of the operating pressures and temperatures, the critical pressures and temperatures, the interior volume, and the wall thickness of the container and the Youngs Modulus (E), Shear Modulus (G), Bulk Modulus (K), Loss Modulus (E′), Storage Modulus (E″), creep compliance properties (Prony coefficients), and energy release rate (dE/dt) of the plastic material. Finally, the snapping frame is integrally formed in the base of the container, wherein the snapping frame has its convex base shape before activation when the operating pressure in the interior volume is less than or equal to the critical pressure.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a cross-sectional, schematic illustration of a container including a snapping frame according to the present disclosure when the internal pressure of the frame is less than a critical pressure and the frame is not activated;

FIG. 2 is a cross-sectional, schematic illustration of the frame shown in FIG. 1 when the internal pressure of the frame equals the critical pressure and the frame is not activated;

FIG. 3 is a cross-sectional, schematic illustration of the frame shown in FIGS. 1 and 2 when the internal pressure of the frame exceeds the critical pressure and the frame is activated;

FIG. 4 is a graph that illustrates the general response of the pressure inside the frame before and after the frame is activated;

FIG. 5 is a graph that illustrates the container effective volume before and after the frame is activated;

FIG. 6 illustrates a finite element simulation of the pressurized container with the snapping frame inactive;

FIG. 7 illustrates a finite element simulation of the pressurized container with the snapping frame activated;

FIG. 8 is a graph illustrating the sudden pressure drop in the container as the snapping frame is activated; and

FIG. 9 is a graph illustrating a well-known example of a convex function of a single variable for the squaring function y=x2.

### DETAILED DESCRIPTION OF THE INVENTION

In this specification and in the claims that follow, reference will be made to a number of terms which shall be defined to have the following meanings ascribed to them. “Include,” “includes,” “including,” “have,” “has,” “having,” “comprise,” “comprises,” “comprising,” or like terms mean encompassing but not limited to, that is, inclusive and not exclusive. The indefinite article “a” or “an” and its corresponding definite article “the” as used in this disclosure means at least one, or one or more, unless specified otherwise. Directional terms as used in this disclosure—for example up, down, right, left, front, back, top, bottom—are made only with reference to the figures as drawn and the coordinate axis provided with those figures and are not intended to imply absolute orientation.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The devices, methods, and processes of the disclosure include those having any value or any combination of the values, specific values, more specific values, and preferred values described.

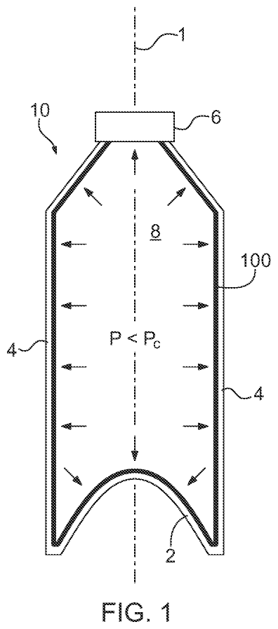

Referring now to the drawing, in which like reference numbers refer to like elements throughout the various figures that comprise the drawing, FIG. 1 shows a blow-molded plastic container 10 such as may be used in the packaging of food products that require thermal processing during packaging. Such food products include liquids (which includes semi-solids) such as, for example, fruit juices, and fruits and vegetables in liquids such as, for example, peaches, pears, pickles, peas, sauerkraut, and the like. When such food products are packaged, they require exposure to high temperatures in connection with processes such as, for example, hot-fill, retort, and pasteurization to ensure bacteria are eliminated. Such containers can typically be designed to contain liquid volumes of, for example, 8 ounces (227 g), 10 ounces (283 g), 12 ounces (340 g), 15 ounces (425 g), 20 ounces (567 g), 24 ounces (680 g), 32 ounces (907 g), or the like.

The container 10 has a base 2 for supporting the container 10. The container 10 has a longitudinal axis 1 when the container 10 is standing upright on its base 2 (as shown). A sidewall 4 extends upwardly from the base 2 and ends in an open top circumscribed by a flange or neck section (not shown). The flange or neck section can be closed with a cap 6 that seals the container 10 and confines a substance or product 8 inside the container 10. The base 2, sidewall 4, and flange or neck section comprise the body of the container 10.

The container 10 can have any geometry, shape, or size. For example, the container 10 can be round, oval, polygonal, and irregular. Suitable containers 10 can be a jar-type, can-type, carafe, wide mouth, and any other type container known to those of ordinary skill in the art. Suitable features of the container 10 can include pressure-absorbing features, grip-enhancing features, shoulders, bumpers, finishes, chimes, standing rings, necks, and other features known to those of ordinary skill in the art. More specifically, the container 10 can have sidewalls 4 of varying thicknesses. Preferably, the sidewall 4 has a density of between about 1.370 g/cc and 1.385 g/cc. Wall thicknesses in the area of the base 2 can vary but for food container applications the thickness of the sidewall 4 in the base area will be from about 0.012 inches (0.030 cm) to about 0.016 inches (0.040 cm).

The container 10 is preferably a pressure-adjustable container, in particular a hot-fill container that is adapted to be filled with the product 8 at a temperature above room temperature. The container 10 may be formed in a manner described in U.S. Pat. No. 10,710,765, which is incorporated in this document by reference in its entirety. The container 10 may be a single layer plastic container or a multilayer plastic container comprising functional layers such as, for example, active and/or passive oxygen barrier layers.

In preferred embodiments, the container 10 is in the form of a plastic. The term “plastic” is defined as any polymeric material that is capable of being shaped or molded, with or without the application of heat. Usually plastics are a homo-polymer or co-polymer of high molecular weight. Plastics fitting this definition include, but are not limited to, polyolefins, polyesters, nylon, vinyl, acrylic, polycarbonates, polystyrene, and polyurethane. As used in this document, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” includes all possible geometrical configurations of the molecule. These configurations include, but are not limited to isotactic, syndiotactic, and random symmetries.

The plastic container 10 may be composed of any thermoplastic polymeric material that may be formed into the desired shape disclosed in this document. Suitable polymeric materials include polyolefins such as polyethylene (PE) or polypropylene (PP) as well as polyesters such as polyethylene terephthalate (PET), nylons, polycarbonates, polyvinylchloride (PVC), and copolymer PVC. Examples of such materials include ethylene based polymers, including ethylene/vinyl acetate, ethylene acrylate, ethylene methacrylate, ethylene methyl acrylate, ethylene methyl methacrylate, ethylene vinyl acetate carbon monoxide, and ethylene N-butyl acrylate carbon monoxide, polybutene-1, high and low density polyethylene, polyethylene blends and chemically modified polyethylene, copolymers of ethylene and C1-C6 mono- or di-unsaturated monomers, polyamides, polybutadiene rubber, polyesters such as polyethylene terephthalate, polyethylene naphthalate, polybutylene terephthalate; thermoplastic polycarbonates, atactic polyalphaolefins, including atactic polypropylene, polyvinylmethylether and others; thermoplastic polyacrylamides, polyacrylonitrile, copolymers of acrylonitrile and other monomers such as butadiene styrene; polymethyl pentene, polyphenylene sulfide, aromatic polyurethanes; styrene-acrylonitrile, acrylonitrile-butadiene-styrene, styrene-butadiene rubbers, acrylontrile-butadiene-styrene elastomers, polyphenylene sulfide, A-B, A-B-A, A-(B-A)n-B, (A-B)n-Y block polymers wherein the A block comprises a polyvinyl aromatic block such as polystyrene, the B block comprises a rubbery midblock which can be polyisoprene, and optionally hydrogenated, such as polybutadiene, Y comprises a multivalent compound, and n is an integer of at least 3, and mixtures of these substances. The thermoplastic materials, which can be used, are generally polymers such as polyethylene (PE) or polyethylene terephthalates (PET), polyethylene glycol terephthalates, or polypropylene (PP). Polyamide (PA) or ethylenevinyl alcohol (EVOH) can be used for possible further layers situated between the inner or outer edge layers. It is also possible, however, to use any other plastics that are melt processable. Suitable containers can be produced from physical PET/PEN resin blends, polyethylene naphthalene (PEN) copolymers, or PEN homopolymers. Suitably, the thermoplastic polymer used to make the plastic container 10 is a transparent, opaque, or partially opaque polymer.

The container 10 preferably comprises a material selected from the group consisting of a polyester resin and polypropylene. Suitable polyester resins include poly(ethylene)terephthalate (PET), homopolymers of poly(ethylene)-phthalate, copolymers of poly(ethylene)terephthalate, poly(ethylene)isophthalate, poly(ethylene)naphthalate, poly(dimethylene)terephthalate, and poly(butylene)terephthalate. In more preferred embodiments, the container 10 comprises PET. Preferably, the PET has an intrinsic viscosity of from about 0.72 dL/g to about 0.86 dL/g. Suitable PET resins include bottle-grade PET resins.

The plastic container 10 may be formed by any conventional molding technique, such as two-stage blow molding. In two-stage blow molding, a pre-form of the plastic is made by injection molding. The pre-form provides the mass of material that eventually is blown into final shape, but it also may include in substantially final form such features as the container neck and annular flange. The pre-form is reheated, enclosed within the halves of a blow mold, and thereafter expanded in the mold. Under such a process, the plastic container 10 may be formed integrally in a one-piece construction. Blow molding techniques, as well as other techniques for manufacturing plastic containers, are well known in the art.

The burst pressure (or failure pressure) of the body of the container 10 is typically supplied by the manufacturer of the container 10 as determined during standard testing of the container 10 during manufacture. The minimum burst pressure is suitably greater than 100 psig (690 kpa), or greater than 150 psig (1,035 kpa), or greater than 200 psig (1,380 kpa), or at least 210 psig (1,450 kpa). The pressure inside the aerosol container 10 is suitably no greater than 100 psig (690 kpa) at 130° F. (54° C.), or 125 psig (860 kpa) at 130° F. (54° C.), or 150 psig (1,035 kpa) at 130° F. (54° C.), or 180 psig (1,240 kpa) at 130° F. (54° C.).

As shown in FIG. 1, the container 10 includes a snapping frame 100 incorporated on or into the body of the container 10. Preferably, the frame 100 is an integral part of the container 10 and is introduced into the body of the container 10 during the manufacturing process. By “integral” is meant a single piece or a single unitary part that is complete by itself without additional pieces, i.e., the part is of one monolithic piece formed as a unit without another part. Thus, preferably, the frame 100 and the container 10 form a one-piece body where the frame 100 is made of the same material as the body of the container 10 itself. The frame 100 has a global convex shape where the frame 100 is integrated into the base 2 of the container 10.

The convex geometry of the frame 100 in the region of the base 2 of the container 10 is defined by specified curvature parameters. The curvature parameters are designed based on one or more of the following predetermined characteristics: the operating or working pressures and temperatures of the container; the critical pressures and temperatures of the container; the volume of the container; the wall thickness of the container; the Youngs Modulus (E), Shear Modulus (G), Bulk Modulus (K), Loss Modulus (E′), Storage Modulus (E″), and creep compliance properties (Prony coefficients) of the material used to construct the container; and the shell energy release rate (dE/dt). By “predetermined” is meant determined beforehand, so that the predetermined characteristic must be determined, i.e., chosen or at least known, in advance of some event (in this case, manufacture of the container 10 including the frame 100). The specific base geometry can be defined by a formula as a function, for example, of one or more of temperature, pressure, and volume.

In mathematics, a real-valued function defined on an n-dimensional interval is called convex (or convex downward or concave upward) if the line segment between any two points on the graph of the function lies above or on the graph. Equivalently, a function is convex if its epigraph (the set of points on or above the graph of the function) is a convex set. A twice-differentiable function of a single variable is convex if and only if its second derivative is nonnegative on its entire domain. A well-known example of a convex function of a single variable includes the squaring function y=x² as depicted in FIG. 9. The convex geometry of the frame 100 may not be defined by one smooth profile such as y=x² profile; rather, the geometry might be defined by a combination of different curvatures (e.g., y=x²+2*x³+c), perhaps with some local sharp edges, but the overall geometry follows a convex shape.

The frame 100 is activated (i.e., snaps) when the internal pressure (P) of the container 10 increases beyond the working pressure range defined by a critical pressure (Pc). Once activated by increased pressure, the snapping frame 100 suddenly pops out and adds extra volume to the container 10 and subsequently decreases the internal pressure of the container 10 to below the critical pressure limit. In the illustrated example, the bottom of the frame 100 in the area of the base 2 of the container 10 pops. In other embodiments, however, the frame 100 might pop in other areas of the container 10 (e.g., in the sidewalls 4).

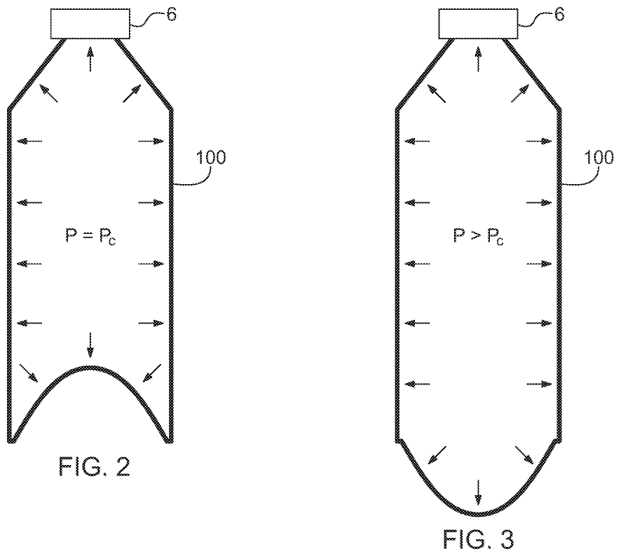

FIGS. 1, 2, and 3 illustrate the snapping frame 100 in three modes. In all three figures, the pressure (P) inside the container 10 is illustrated with arrows directed outward from the inside the container 10 against the frame 100. First, as shown in FIG. 1, the frame 100 is not activated because the pressure inside the container 10 is below the critical pressure (i.e., P <Pc). Next, FIG. 2 shows the frame 100 at the very instant that the pressure inside the container 10 equals the critical pressure (i.e., P=Pc). Again, the frame 100 is not yet activated. Finally, as shown in FIG. 3, the pressure inside the container 10 rises above the critical pressure (i.e., P>Pc). The frame 100 is immediately, suddenly, and instantaneously activated once P>Pc. In the embodiment illustrated, the frame 100 pops out into a concave shape in the area of the base 2 of the container 10. Thus, the snapping adds extra volume to the container 10 which results in a sudden decrease of the internal pressure so that the internal pressure returns to an amount less than the critical pressure (i.e., the condition shown in FIG. 1). The popping action occurs in a fraction of a second (less than one second). Thus, by immediately, suddenly, and instantaneously is meant that the frame 100 pops or bulges out less than one second after the internal pressure exceeds the critical design pressure.

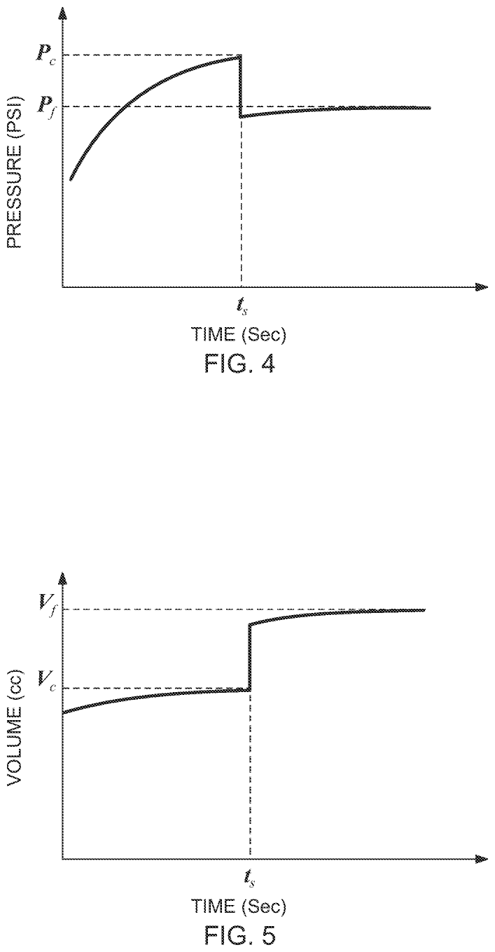

FIG. 4 is a graph that illustrates the general response of the pressure inside the frame 100 before and after snapping occurs at a time, t, of tₛ (i.e., when t=tₛ). FIG. 5 is a graph that illustrates the container effective volume before and after snapping occurs at t=tₛ. In FIGS. 4 and 5, the subscripts “f” and “c” denote “final” pressure and volume and “critical” pressure and volume, respectively.

The governing equations predicting the pressure drop after snapping occurs at t=tₛ as a function of effective volume increase are (with the arrow representing an adiabatic process):

PV=nRT [symbol] P_{f}=V_{c}P_{c}/V_{f}

The ideal gas law, also called the general gas equation, is the equation of state of a hypothetical ideal gas. It is a good approximation of the behavior of many gases under many conditions, although it has several limitations. It was first stated by Emile Clapeyron in 1834 as a combination of the empirical Boyle's law, Charles's law, Avogadro's law, and Gay-Lussac's law. The ideal gas law is often written in an empirical form PV=nRT, where P, V, and T are the pressure, volume, and temperature; n is the amount of substance; and R is the ideal gas constant (which is the same for all gases).

Combining the laws of Charles, Boyle, and Gay-Lussac gives the combined gas law, which takes the same functional form as the ideal gas law save that the number of moles is unspecified and the ratio of PV to T is simply taken as a constant. When comparing the same substance under two different sets of conditions (set 1 and set 2), but at constant temperature, the law can be written as P₁V₁=P₂V₂, or P₁=P₂V₂/V₁. Defining the first set of conditions as those that exist in the frame (f) and the second set of conditions as those that exist in the frame at the critical (c) pressure and volume, then P_{f}=V_{c}P_{c}/V_{f}.

### EXAMPLE

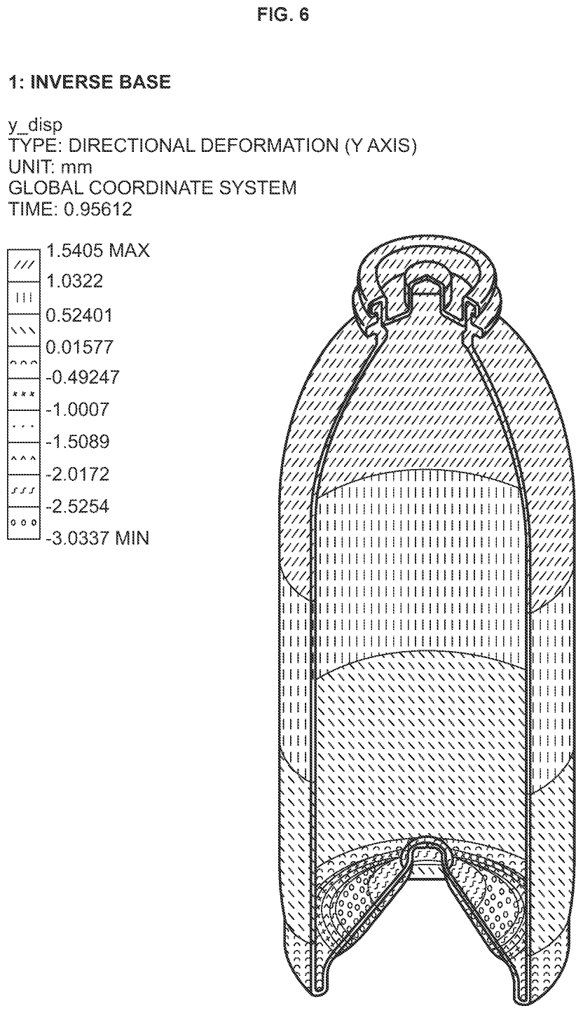

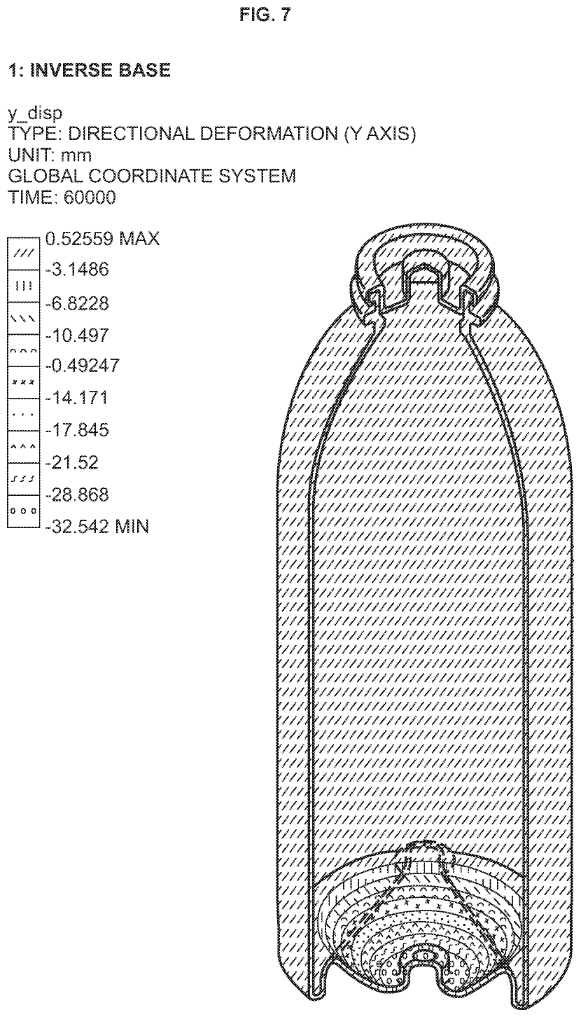

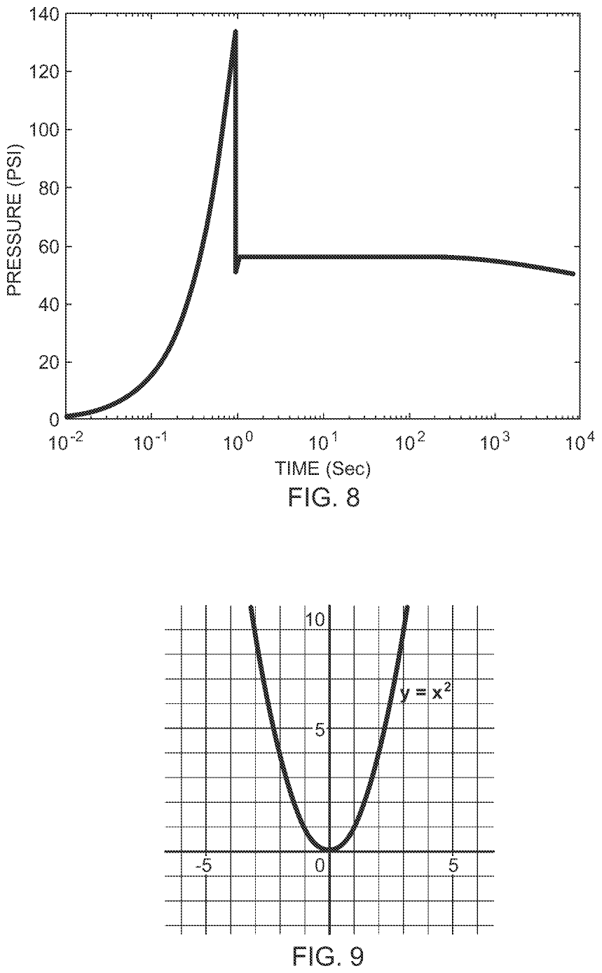

The following example is included to more clearly demonstrate the overall nature of the disclosure. This example is exemplary, not restrictive, of the disclosure. The example illustrates finite element simulations of the pressure drop in an actual example container 10 with the snapping frame 100. Specifically, FIG. 6 illustrates a finite element simulation of the pressurized container 10 with the snapping frame 100 inactive for P<P_{c}. FIG. 7 illustrates a finite element simulation of the pressurized container 10 with the snapping frame 100 activated for P>P_{c}. FIG. 8 is a graph illustrating the sudden pressure drop in the container 10 as the snapping frame 100 is triggered when P first exceeds Pc.

The finite element method (FEM) is the most widely used method for solving problems of engineering and mathematical models. A typical problem area of interest is the traditional field of structural analysis. The FEM is a particular numerical method for solving partial differential equations in two or three space variables (i.e., some boundary value problems). To solve a problem, the FEM subdivides a large system into smaller, simpler parts that are called finite elements. This is achieved by a particular space discretization in the space dimensions, which is implemented by the construction of a mesh of the object: the numerical domain for the solution, which has a finite number of points. The finite element method formulation of a boundary value problem finally results in a system of algebraic equations. The method approximates the unknown function over the domain. The simple equations that model these finite elements are then assembled into a larger system of equations that models the entire problem. The FEM then uses variational methods from the calculus of variations to approximate a solution by minimizing an associated error function. Studying or analyzing a phenomenon with FEM is often referred to as finite element analysis (FEA).

Several of the important features of the container 10 having the frame 100 are highlighted below. The frame 100 has a convex base shape (curved inward) before activation and a concave base shape (curved outward) after snapping upon reaching a critical pressure during use of the container 10. The article is a one-piece combination of the frame 100 and the container 10, such that the integral article can be manufactured of one material. The frame 100 is activated via pressure rather than vacuum. The activation is sudden (less than one second) rather than gradual. And deformation of the frame preferably occurs only in the area of the base 2 of the container and neither in the sidewalls 4 nor in the top of the container 10 (or in the cap 6 used to close the container 10).

Although the idea of deforming frames has been exploited in reducing vacuum in the hot fill process of plastic bottles, the vacuum buckling frames are different in nature from the snapping frame 100 used in the pressurized container 10. Vacuum frames use concave shapes whereas the snapping frame 100 uses a convex shape. The vacuum frame is activated manually or automatically in the presence of a vacuum where the snapping frame 100 activates automatically in the presence of pressure. The vacuum frames are usually activated with an external force during the hot-fill process or automatically in a gradual deformation whereas the pressurized snapping frame 100 activates automatically and suddenly. The method of using the container 10 having the frame 100 includes the step of the frame 100 popping suddenly under increased internal pressure to increase the volume of the container 10. Thus, catastrophic failure of the pressurized container 10 is avoided when the internal pressure of the container 10 passes a critical threshold.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure. It is expressly intended, for example, that all ranges broadly recited in this document include within their scope all narrower ranges which fall within the broader ranges.

What is claimed:

1. A plastic container for storing a product, the container comprising:
a base formed of a plastic material;
sidewalls formed of the plastic material and extending upwardly from the base, ending in an open top adapted to be closed by a cap, and with the base defining an interior volume; and
a snapping frame integrally formed in the base of the plastic material, wherein the frame has a convex base shape before activation when the pressure in the interior volume is less than or equal to a predetermined critical pressure and has a concave base shape immediately after activation when the pressure in the interior volume is greater than the predetermined critical pressure, thereby increasing the interior volume and avoiding catastrophic failure of the container.

2. The plastic container of claim 1 wherein the sidewalls have a density of between about 1.370 g/cc and 1.385 g/cc.

3. The plastic container of claim 1 wherein the sidewalls have a thickness in the area of the base between about 0.030 cm to about 0.040 cm.

4. The plastic container of claim 1 wherein the plastic material is a polyester resin or polypropylene.

5. The plastic container of claim 4 wherein the plastic material is poly(ethylene)terephthalate having an intrinsic viscosity of from about 0.72 dL/g to about 0.86 dL/g.

6. The plastic container of claim 1 wherein the container has a minimum burst pressure of greater than about 690 kpa.

7. The plastic container of claim 1 wherein the snapping frame is integrally formed in the sidewalls as well as in the base of the plastic material.

8. A method of using a container for storing a product, the method comprising:
providing a container having (i) a base formed of a plastic material, (ii) sidewalls formed of the plastic material and extending upwardly from the base, ending in an open top adapted to be closed by a cap, and with the base defining an interior volume, and (iii) a snapping frame integrally formed in the base of the plastic material, wherein the frame has a convex base shape before activation when the pressure in the interior volume is less than or equal to a predetermined critical pressure; and
allowing the pressure in the interior volume to increase above the predetermined critical pressure, at which pressure the snapping frame activates and has a concave base shape thereby increasing the interior volume and avoiding catastrophic failure of the container.

9. The method according to claim 8 wherein the snapping frame activates less than one second after the pressure in the interior volume increases above the predetermined critical pressure.

10. The method according to claim 8 wherein the snapping frame activates automatically in response to the pressure increase and is not activated by a vacuum.

11. The method according to claim 8 wherein the plastic material is poly(ethylene)terephthalate having an intrinsic viscosity of from about 0.72 dL/g to about 0.86 dL/g.

12. The method according to claim 8 wherein the snapping frame is integrally formed in the sidewalls as well as in the base of the plastic material.

13. A process of manufacturing a container for storing a product, the process comprising:
selecting a plastic material having predetermined Youngs Modulus (E), Shear Modulus (G), Bulk Modulus (K), Loss Modulus (E′), Storage Modulus (E″), creep compliance properties (Prony coefficients), and energy release rate (dE/dt);
providing a container defining an interior volume and including a base formed of the plastic material and sidewalls being formed of the plastic material, having a thickness, extending upwardly from the base, and ending in an open top adapted to be closed by a cap;
defining the operating and critical pressures and temperatures of the container;
designing a snapping frame having a substantially convex base shape based on one or more of the operating pressures and temperatures, the critical pressures and temperatures, the interior volume, and the wall thickness of the container and the Youngs Modulus (E), Shear Modulus (G), Bulk Modulus (K), Loss Modulus (E′), Storage Modulus (E″), creep compliance properties (Prony coefficients), and energy release rate (dE/dt) of the plastic material; and
integrally forming the snapping frame in the base of the container, wherein the snapping frame has its convex base shape before activation when the operating pressure in the interior volume is less than or equal to the critical pressure.

14. The process according to claim 13 wherein the step of providing the container includes two-stage blow molding of the container.

15. The process according to claim 13 wherein the sidewalls of the container have a density of between about 1.370 g/cc and 1.385 g/cc.

16. The process according to claim 13 wherein the sidewalls of the container have a thickness in the area of the base between about 0.030 cm to about 0.040 cm.

17. The process according to claim 13 wherein the plastic material is a polyester resin or polypropylene.

18. The process according to claim 17 wherein the plastic material is poly(ethylene)terephthalate having an intrinsic viscosity of from about 0.72 dL/g to about 0.86 dL/g.

19. The process according to claim 1 wherein the container has a minimum burst pressure of greater than about 690 kpa.

20. The process according to claim 13 wherein the snapping frame is integrally formed in the sidewalls as well as in the base of the plastic material.
